(19) United States
(12) Patent Application Publication
(10) Pub. No.: US 2010/0254543 A1
(43) Pub. Date: Oct. 7, 2010

(54) CONFERENCE MICROPHONE SYSTEM

(75) Inventor: Morgan KJØLERBAKKEN, Oslo (NO)

Correspondence Address: BIRCH STEWART KOLASCH & BIRCH, PO BOX 747, FALLS CHURCH, VA, 22040-0747, US

(73) Assignee: SquareHead Technology AS, Oslo (NO)

(21) Appl. No.: 12/698,259

(22) Filed: Feb. 2, 2010

Related U.S. Application Data
(60) Provisional application No. 61/149,585, filed on Feb. 3, 2009.

(51) Int. Cl. H04R 3/00

(52) U.S. Cl. 381/92; 345/173; 348/77

(57) ABSTRACT

A method and system for controlling selective audio output of captured sounds from an audience by means of a system comprising at least one microphone array located above or in front of said audience, and at least one camera.

### TECHNICAL FIELD

The present invention concerns directive controlling of recorded sound. More specifically the invention concerns a method and system for controlling sound from an audience by providing and controlling virtual microphones.

### PRIOR ART

When performing a conference or meeting, typically one or more speakers will address an audience with several participant located at an area in front of the speaker(s).

When one or more participants want to say something, a microphone must be passed to that person for the voice to be heard by all participants. This is a cumbersome and time consuming method.

There is however systems comprising microphone arrays for picking up and amplify sound from specific locations.

Applicants own publication PCT/NO2006/000334, hereby included as reference, describes a method and system for digitally directive focusing and steering of sampled sound within a target area for producing a selective audio output to accompany video. This is performed by receiving position and focus data from one or more cameras shooting an event, and by using this input data for generating relevant sound output together with the image.

This system will not be practical for controlling sound with ease from one or more specific locations in an audience. When operating a camera, only one location can be pointed out at a time, i.e. the location where the lens is pointed and zoomed at. Further, the use of this type of interface when the controlling of sound is the main purpose is not regarded as user-friendly.

The present invention describes a user friendly method and system for controlling one or more “virtual” microphones. A virtual microphone can be created by performing simultaneous DSP (Digital signal processor) processing of the signals from a combination of the individual microphone array elements. This is further described in the cited publication above.

The problem to be solved by the present invention may be regarded as how to provide a method and system for easy access and control of virtual microphones. According to the invention, this problem has been solved by providing a touch sensitive display showing an overview image of the audience, and using this display for controlling one or more virtual microphones.

### SUMMARY

The present invention comprises a method for controlling selective audio output of captured sounds from any location in an audience by means of a system comprising at least one microphone array located above or in front of said audience, at least one camera focusing on the audience. The method comprises the following steps performed in a signal processing device:
receiving an overview image of the audience from said camera, and sound from said audience by means of said microphone array;
presenting said overview image of the audience together with control objects on a display which can detect the presence and location of a touch input at an (x, y) location within the area of the display;
receiving touch input(s) at one or more (x, y) location(s) on said display, instructing a specific action to be performed at corresponding location(s) in the audience, and
applying signal processing in said signal processing device for performing said action by controlling steering, focus and sound level of the sound from the microphones in said microphone array, thus controlling one or more virtual microphones at one or more location(s) in the audience, said location(s) corresponds to the input location(s) on the display.

The invention is also described by a processing device and system for performing the same. This is further defined in the main claims.

Further features are defined in the accompanying dependent claims.

### DETAILED DESCRIPTION

In the following, the invention will be described in detail with reference to the drawings where:

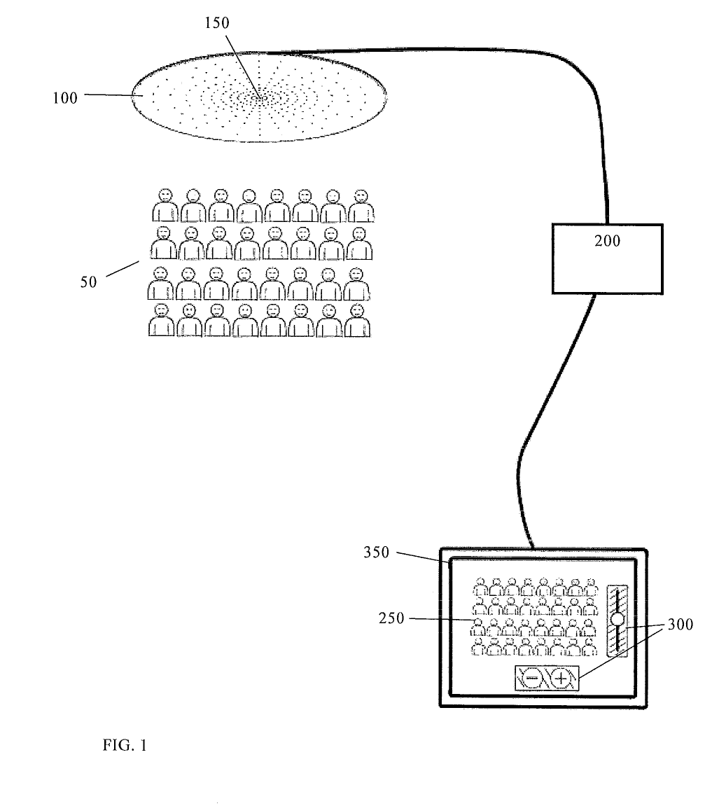

FIG. 1 shows the system for controlling a microphone array;

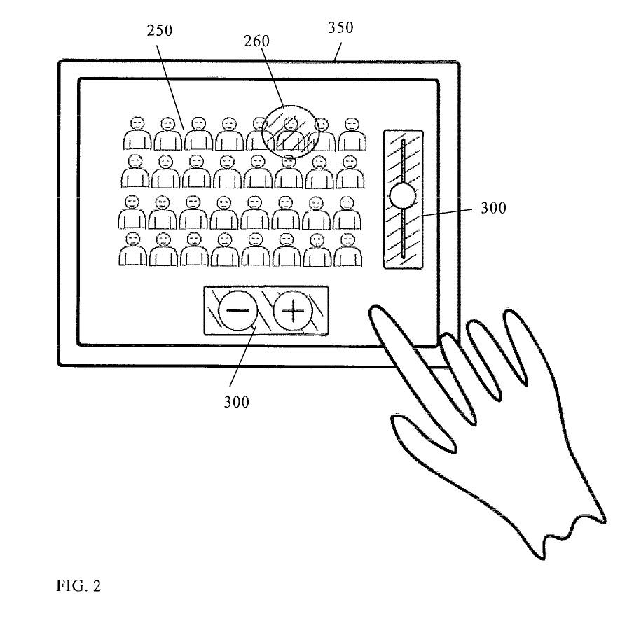

FIG. 2 shows the display for controlling virtual microphones for an audience;

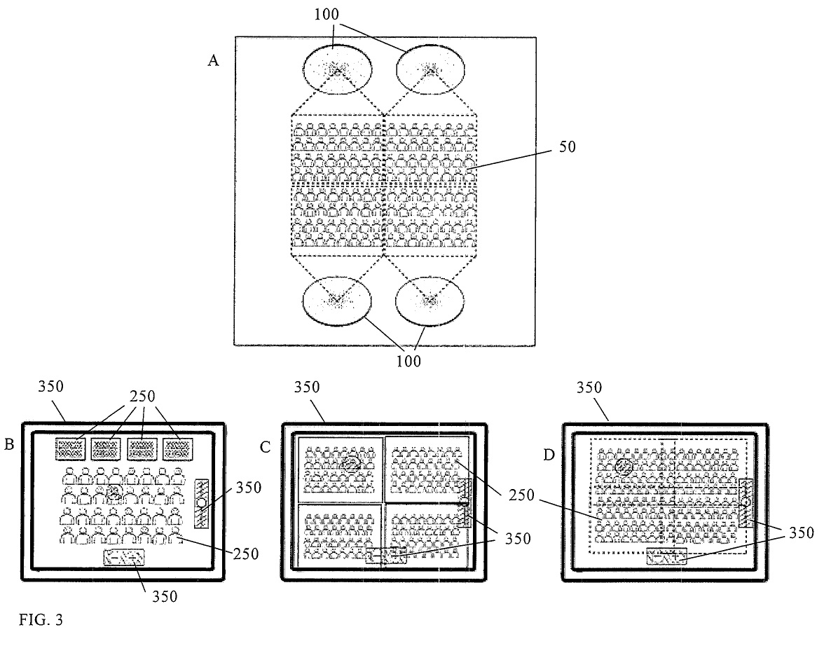

FIG. 3 shows a system for controlling several microphone arrays.

The invention is described by a system for controlling selective audio output of captured sounds from any location in an audience.

FIG. 1 shows the system for controlling a microphone array for enabling the selective audio output.

The system comprises a processing device 200, at least one microphone array 100 located above or in front of the audience 50, and at least one camera 150 focusing on the audience 50, and a display 350 which can detect the presence and location of a touch input, used for controlling one or more virtual microphones at one or more location(s) in the audience 50. All said units are connected to each other, either by wire, or wirelessly, or in a combination of these.

The processing device 200 is used for controlling the selective audio output of the captured sounds from any location in an audience 50, and comprises means for receiving an overview image 250 of the audience 50 from said camera 150, together with sound from said audience 50 by means of said microphone array 100. The received image will be processed before it is presented on the display 350.

The sound is captured by a unit comprising a broadband microphone array located above or in front of the audience.

One or more cameras 150 can be used for capturing images of the audience 50. One or more cameras may be integrated in a unit comprising said microphone array 100, or the cameras may be positioned at other locations for capturing images of the audience 50.

The cameras used can be both video camera and still picture cameras, or a combination of these.

A compact and robust system for both recording sound and image is achieved by integrating the camera(s) in the unit comprising the microphone array 100.

In order to capture all participants in an audience with only one camera, the camera can be equipped with a fisheye lens. It is known that the resulting images from such a lens will produce barrel distortion. This will be corrected in the processing device 200 before the resulting undistorted images are presented on the display 350.

For larger audiences two or more microphone arrays 100 located at different locations above or in front of the audience 50 may be used. This set-up will be further described below.

In the following the controlling of the system will be described. The processing device 200 will coordinate and control selective audio output of captured sounds from any location in an audience 50. Although more than one camera 150 and microphone array 100 can be used according to the invention, only one camera and microphone array will, for simplification, be included in the following description of the processing device 200.

The processing device 200 comprises means for receiving an overview image 250 of the audience 50 from a camera 150, together with sound from an audience 50 by means of a microphone array 100.

The processing device 200 will then process the image by sizing it to fit on the display 350, removing unwanted artefacts, backgrounds and distortions before the image is presented on the display 350 as an overview image 250 of the audience 50 together with control objects 300.

By using a display 350 that can detect the presence and location of a touch input at an (x, y) location within area of the display 350 it is possible to control the signal processing of the signals from each microphone in the microphone array 100. This signal processing is performed in the processing device 200.

The processing device 200 comprises means for detecting touch input(s) at one or more (x, y) location(s) on said display 350, instructing it to perform a specific action at corresponding location(s) in the audience 50.

The specific action to be performed will depend on the nature of the specific touch input(s), and at which location(s) (x, y) on the display 350.

Based on this, the processing device 200 will carry out the necessary signal processing for controlling steering, focus and sound level of the sound from the microphones in said microphone array 100, thus controlling one or more virtual microphones at one or more location(s) in the audience 50. This signal processing is described in said PCT/NO2006/000334.

The controlling of steering and focusing at one or more specific locations in the audience 50 is performed by implementing 3-dimensional positioning (x, y, z) of one or more locations relative to the microphone array 100. Z is calculated by the processing device 200 from the (x, y) location in the audience and the known height and possible tilt angle of the microphone array 100 above or in front of the audience 50.

The processing device 200 also comprises means for adjusting for geometry aspects influencing sound propagation and acoustic in the room where the audience 50 is located. It also comprises means for adjusting barrel distortion produced by a fisheye lens used on a camera 150.

The processing device 200 can be a stand alone unit connected to said display 350 and microphone array 100. It can also be a unit integrated in said display 350 or in the microphone array 100.

FIG. 2 shows the display for controlling virtual microphones for an audience. The person controlling the display 350 will be presented with an overview image 250 of the audience 50 together with control objects 300 on a display 350. An input or command will be given by touching the display 350 at one or more (x, y) location(s). This will result in a specific action to be performed at corresponding location(s) in the audience 50. The processing device 200 will carry out the command by applying signal processing for performing the action according to the input command by controlling steering, focus and sound level of the sound from the microphones in said microphone array 100. This will control one or more virtual microphones at one or more location(s) in the audience 50.

When executing a touch input, i.e. pressing the screen with a finger or pointing device, at a location on said display 350 showing the image 250 of the audience 50, the focus to or from that location will change by making the location an active area 260 if it was currently inactive, or the other way around inactive if it was currently an active area 260. When an area of the display 350 is an active area 260, it will be indicated on the display 350, and the processing device 200 will control the microphone array 100 to focus on that area, thus providing a virtual microphone for the active area 260. When the active area is pressed again it will become inactive, thus remove the virtual microphone.

More than one area of the audience 50 may be activated at the same time, thereby providing more that one virtual microphone.

When pressing the control object 300, the processing device 200 will control sound level of active virtual microphone(s). Pressing the + sign will add an active area 260, and pressing the − sign will remove an active area 260.

A pressing and dragging motion of an active area 260 will move this area to another location on said display 350. This will cause the signal processing device 200 to change the steering and focus of sound from one corresponding location in the audience to another, resulting in a fading out to fading in effect.

FIG. 3 shows a system for controlling several microphone arrays. In this implementation of the invention, the system comprises two or more microphone arrays 100 located at different locations above or in front of the audience 50. These are all connected to the processing device 200.

FIG. 3A show an audiences 50 covered by four microphone arrays 100 with integrated cameras 150.

The processing device 200 will in this case comprise means for receiving sound signals from several microphone arrays 100, i.e. four, together with images from the cameras 50 for presenting processed images from the cameras on the display 350 together with said control object 300.

The different cameras 150 and microphone arrays 100 will each cover different areas of an audience 50. These areas will then be presented on the display 350.

FIG. 3B shows a first way of presenting the audience. It shows one area in focus being displayed larger than the other areas. Performing a touch input on one of the smaller areas will change that area to be in focus for controlling the virtual microphones.

FIG. 3C shows a second way of presenting the audience. All areas are presented equally sized on the display 350. This will enable easy control of the sound from a virtual microphone from a first location in one area to a second location in another area by performing a touch and drag action.

FIG. 3D shows all four areas in FIG. 3A, covered by the different microphone arrays and cameras, as one resulting total area image covering the audience 50. This is achieved in the processing device 200 by processing the images by seamlessly stitching the images 250 of each area together.

A man skilled in the art will understand that the present invention may be implemented in other ways without deviating from the scope of the invention as defined in the claims.

1. A method for controlling selective audio output of captured sound from any location in an audience by means of a system comprising at least one microphone array located above or in front of said audience, at least one camera (150) focusing on the audience, and where the method is wherein performing the following steps in a signal processing device:
receiving an overview image of the audience from said camera, and sound from said audience by means of said microphone array;
presenting said overview image of the audience together with control objects on a display which can detect the presence and location of a touch input at an (x, y) location within the area of the display;
receiving touch input(s) at one or more (x, y) location(s) on said display, instructing a specific action to be performed at corresponding location(s) in the audience, and
applying signal processing in said signal processing device for performing said action by controlling steering, focus and sound level of the sound from the microphones in said microphone array, thus controlling one or more virtual microphones at one or more location(s) in the audience, said location(s) corresponds to the input location(s) on the display.

2. A method according to claim 1, wherein receiving a touch input at a location on said display showing the image of the audience will change the focus to or from that location by making the location an active area if currently inactive or inactive if currently an active area, where an active area is an area provided with a virtual microphone, and an inactive area is not provided with a virtual microphone.

3. A method according to claim 1 or 2, wherein that receiving a touch input at a location on said display showing the control object, will control sound level of active virtual microphone(s), and adding or removing of virtual microphones.

4. A method according to claim 1, wherein receiving a touch input at an (x, y) location on said display followed by a dragging motion to another location on said display will cause the signal processing device to change the steering and focus of sound from one corresponding location in the audience to another.

5. A method according to claim 1, wherein the steering and focusing at one or more specific locations in the audience is performed by implementing 3-dimensional positioning (x, y, z) for one or more locations relative to the microphone array, where z is calculated from said (x, y) location and the known height and possible tilt angle of the microphone array above or in front of the audience.

6. A method according to claim 5, wherein the signal processing including 3-dimensional positioning (x, y, z) also includes adjusting for the geometry aspects influencing sound propagation in the room where the audience is located.

7. A method according to claim 1, wherein the method comprises use of several cameras and microphone arrays each covering different areas of an audience, and where these areas are presented on the display with one area in focus being displayed larger than the other areas, and where a touch input on one of the smaller areas will change that area to be in focus for controlling the virtual microphones.

8. A method according to claim 1 or 4, wherein the method comprises use of several cameras and microphone arrays each covering different areas of an audience, and where these areas are presented equally sized on the display, thus enabling controlling the sound from the virtual microphones from a first location in one area to a second location in another area by performing a touch and drag action.

9. A method according to claim 1, wherein the method comprises use of several cameras and microphone arrays each covering different areas of an audience, and where these areas are presented on the display as one total area covering the audience by seamlessly stitching the images of each area together.

10. A processing device for controlling selective audio output of captured sounds from any location in an audience by means of a system comprising at least one microphone array located above or in front of the audience, at least one camera focusing on the audience, and where the processing device is
wherein comprising means for:
receiving an overview image of the audience from said camera, and sound from said audience by means of said microphone array;
presenting said overview image of the audience together with control objects on a display which can detect the presence and location of a touch input at an (x, y) location within area of the display;
receiving touch input(s) at one or more (x, y) location(s) on said display, instructing the signal processing device to perform a specific action at corresponding location(s) in the audience, and
applying signal processing for performing said action by controlling steering, focus and sound level of the sound from the microphones in said microphone array, thus controlling one or more virtual microphones at one or more location(s) in the audience, said location(s) corresponds to the input location(s) on the display.

11. A processing device according to claim 10, wherein the processing device for controlling steering and focusing at one or more specific locations in the audience comprises means for implementing 3-dimensional positioning (x, y, z) of one or more locations relative to the microphone array, where z is calculated by the processing device from said (x, y) location and the known height and possible tilt angle of the microphone array above or in front of the audience.

12. A processing device according to claim 10, wherein comprises means for adjusting for geometry aspects influencing sound propagation in the room where the audience is located.

13. A processing device according to claim 10, wherein comprises means for adjusting barrel distortion produced by a fisheye lens used on said camera for presenting an undistorted images on the display.

14. A processing device according to claim 10, wherein comprises means for receiving sound signals from two or more microphone arrays and images from two or more cameras for presenting the images from the cameras on said display together with said control object.

15. A processing device according to claim 10, wherein it is integrated in said display.

16. A processing device according to claim 10, wherein it is integrated in said microphone array.

17. A processing device according to claim 10, wherein it is a stand alone unit connected to said display and microphone array.

18. System for controlling selective audio output of captured sounds from any location in an audience, wherein comprising a processing device according to claim 10, at least one microphone array located above or in front of the audience, and at least one camera focusing on the audience, and a display which can detect the presence and location of a touch input, used for controlling one or more virtual microphones at one or more location(s) in the audience.

19. System according to claim 18, wherein said camera is integrated in a unit with said microphone array.

20. System according to claim 18, wherein comprising two or more microphone arrays located at different locations above or in front of the audience, and connected to said processing device.
